(19) United States
(12) Patent Application Publication
(10) Pub. No.: US 2009/0320630 A1
(43) Pub. Date: Dec. 31, 2009

(54) Linear drive, in particular a rack and pinion drive

(76) Inventors: Thomas Bayer, Igersheim (DE); Frank Michel, Bad Mergentheim (DE)

Correspondence Address: BACHMAN & LAPOINTE, P.C., 900 CHAPEL STREET, SUITE 1201, NEW HAVEN, CT, 06510, US

(21) Appl. No.: 10/588,747

(22) PCT Filed: Nov. 23, 2004
(86) PCT No.: PCT/EP2004/013294

§ 371 Date: Mar. 6, 2009

(30) Foreign Application Priority Data
Feb. 13, 2004 (DE) 10 2004 007 448.8

(51) Int. Cl. F16H 55/28

(52) U.S. Cl. 74/409

(57) ABSTRACT

The invention relates to a linear drive, in particular a rack and pinion drive, comprising at least one motor element (2) which is mounted on or in a retaining element (1.1, 1.2). The motor element (2) drives, directly or indirectly, a pinion (4), optionally, via an integrated drive (3), said pinion co-operating with a linear guide (5). According to the invention, the retaining element (1.1, 1.2) can be displaced by at least one actuator (12.1 to 12.3) in relation to a receiving element (6).

### BACKGROUND

(1) Field of the Invention

The present invention relates to a linear drive, in particular to a rack and pinion drive, with at least one motor element mounted on or in a retaining element, the motor element driving a pinion directly or indirectly, optionally via an integrated drive, said pinion interacting with a linear guide and to a process for operating the linear drive.

(2) Prior Art

The conventional linear drives or conventional rack and pinion drives are known and common on the market in a wide range of forms and embodiments. In these, a pinion that interacts with a linear guide is driven via a common powertrain using motor element and possibly integrated or downline drive in order to compensate backlash in a gearing. There is generally a slight backlash between pinion and linear guide, in particular a tooth face contact backlash if pinion and linear guide have flanks.

A disadvantage here is that with the conventional linear drives or rack and pinion drives with pinion and rack, machine precision and machine dynamics are significantly reduced, since for example the integrated drive rigidities vary. In addition, the tooth flanks of pinion and rack are subject to a certain wear, which in turn also leads to backlash. The high wear and also the lack of precision is caused in particular by the mechanically hard preload of the integrated drive, resulting in very large integrated drives having to be employed.

Furthermore, a preload force on the pinion is by no means constant, as for example with different loads and speeds, but also accelerations and imprecisions in the linear guide can result in differing wear or exists from the outset due to manufacturing inaccuracies.

In addition, inaccuracies in the linear guide caused by, for example, thermal expansion are not compensated, so that different wear is caused to the linear guide and the pinion. Today, however, a higher precision of a linear drive that moves in relation to a linear guide or of a linear guide that is moved in relation to the stationary linear drive is necessary. This cannot be guaranteed with the conventional linear drives.

Such linear drives can be used, for example, in all machine tools, laser machines, milling machines, wood machining lasers, etc.

### SUMMARY OF THE INVENTION

The object of the present invention is to provide a linear drive of the type mentioned at the beginning that eliminates the above-mentioned disadvantages and that also permits a simple, effective and inexpensive variation of the preload on the pinion in relation to the linear guide during operation and in response to changing loads and accelerations. In addition, the motor current consumption should be reduced, and wear of the pinion and linear guide and integrated drive elements should also be reduced with an increase in overall rigidity.

The features of the characteristics of claim 1 and of the subclaims result in the achievement of this object.

In the present invention it has proved to be particularly advantageous that the retaining element which serves as the mounting for the motor and/or the integrated drive elements and with which the pinion is in contact can be moved in relation to a fixed receiving element by means of an actuator.

Corresponding guide elements are provided that as linear guides can take the form preferably of leaf spring elements, roller guides, etc. that permanently guarantee a certain preload or a variable preload during operation. The selected preload can be permanently held constant during operation in that the force acting on the pinion is permanently measured using corresponding force and/or position sensors and then adjusted via the actuators. In this way a preload force can be permanently held constant during operation. Force sensors for feed and/or preload force are preferably integrated into the unit so that the preload force can be variably influenced via the actuators during operation. This also ensures that the pinion contacts the linear guide with a permanently constant, variable preload force with the preload force being adapted or varied according to the load and/or acceleration and/or speed during operation. This allows backlash to be reliably avoided with an increased machine precision and higher machine dynamics so that a higher machine performance on, for example, machine tools with high-speed infeed such as for example laser cutting and laser punching machines can be guaranteed. Furthermore, an extremely narrow design can be guaranteed thanks to a broad adaption range that guarantees rapid installation during operation with minimum wear and low maintenance costs.

The relatively large adjustment travel permits not only the freedom from backlash with large manufacturing deviations, wear and thermal expansion to be achieved, but also considerably simplifies the installation by eliminating adjustments to the position of the motor element and the alignment and straightness of the linear guide.

### BRIEF DESCRIPTION OF THE DRAWINGS

Further advantages, features and details of the invention can be seen from the following description of preferred illustrative embodiments and from the drawing.

FIG. 1 shows a perspective view of a linear drive according to the invention;

FIG. 2a shows a schematic perspective top view of a further linear drive.

FIG. 2b shows a perspective rear view of the linear drive according to FIG. 2a.

### DETAILED DESCRIPTION OF THE PREFERRED EMBODIMENTS

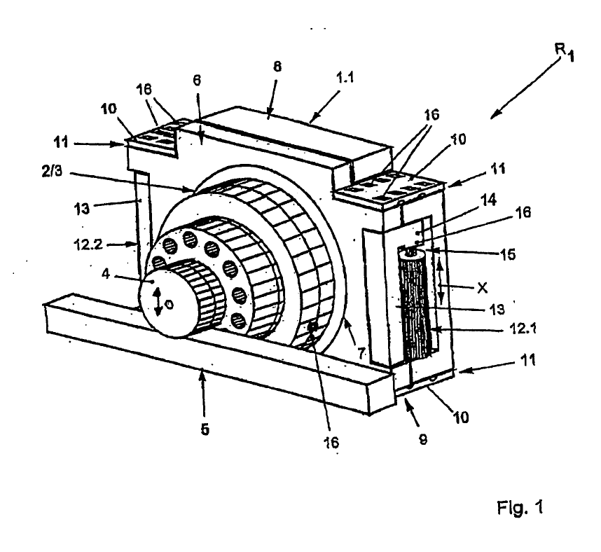

According to FIG. 1, a linear drive R₁ according to the invention exhibits a retaining element 1.1 that has the form roughly of a plate and serves as a mounting for a motor element 2 possibly with a downline or integrated drive 3 on which a pinion 4 is mounted. The pinion 4 interacts with or meshes with a linear guide 5. The pinion 4 can, for example, be designed as a gear wheel and meshes with corresponding tooth faces of the linear guide 5.

The present invention should, however, also cover the case in which, for example, the linear drive R₁ can move or travel in relation to the linear guide 5 in that the pinion is driven, or that the linear drive R₁ is mounted in or on a machine frame or other subframe and drives the linear guide 5. Racks, straight guides, curved tracks or even circular tracks can be provided as the linear guide 5. The invention is not limited to these aspects. It should also be considered that, for example, the pinion 4 interacts with the linear guide 5 only be means of frictional contact and the linear drive R₁ or the linear guide 5 is moved in relation to the linear drive R₁.

In the present illustrative embodiment the motor element 2 and/or integrated drive 3 with mounted pinion 4 engages through a receiving element 6 in the area of an opening 7. The receiving element 6 is preferably designed or arranged so that it is stationary or fixed. The receiving element 6 has a plate-like form and lies close to or a slight distance from and parallel to the retaining element 1.1.

In the area of one upper side 8 and in the area of one lower side 9, retaining element 1.1 and receiving element 6 are linked to one another by guide elements 11 in the form of leaf springs 10, preferably in lateral areas. The guide elements 11 or leaf spring elements 10 permit only a linear guide 5 or a movement of the retaining element 1.1 in relation to the receiving element 6, as indicated in the direction of the double arrow X.

In order to move the retaining element 1.1 in relation to the receiving element 6 back and forth in the direction of the double arrow X shown, and hence to move the motor element 2 and/or integrated drive 3 or its pinion 4 in relation to the linear guide 5 back and forth in linear fashion in the direction of the double arrow X shown, at least one actuator 12.1, 12.2 is mounted above a connecting piece 13 assigned to receiving element 6 between retaining element 1.1 and receiving element 6. The connecting piece 13 exhibits a flange 14 that engages at least partly in a recess 15 of the retaining element 1.1. The actuator 12.1, 12.2, preferably as a piezo actuator, is located between this flange 14 and a flange of the retaining element 1.1 not referenced here. This allows, for example in the event of expansion, the pinion 4 to move against the linear guide 5 in order to guarantee freedom from backlash and two-flank contact at all times.

In order that the corresponding force or preload necessary as a preload force to guarantee constant freedom from backlash between pinion 4 and linear guide 5 can be exactly determined, corresponding force and/or position sensors 16 are assigned to the guide element 11 or the leaf spring element 10. In addition, the corresponding force and/or position sensors 16 can be assigned to the connecting piece 13 and/or the actuator 12.1, 12.2.

The present invention should also cover the case in which at least one force and/or position sensor 16 that can measure horizontal and vertical forces can be assigned to the motor element 2 and/or integrated drive 3 in order to permanently and directly measure the force acting on the pinion 4 and retaining element 1.1. According to the changing feeds or accelerations a permanent and variable preload force or preload between pinion 4 and linear guide 5 can be adapted, controlled and adjusted or varied in order to guarantee freedom from backlash and/or two-flank contact during operation.

In this way the preload forces between pinion 4 and linear guide 5 can be adjusted during operation, for example in the event of changing accelerations or loads or supported loads or transported loads so that a backlash-free connection between pinion 4 and linear guide 5 is guaranteed at all times. This has the advantage that the linear drive R₁ can be moved very exactly and precisely in relation to the linear guide 5, or that the linear guide 5 can be moved very exactly and precisely in relation to the fixed linear drive R₁.

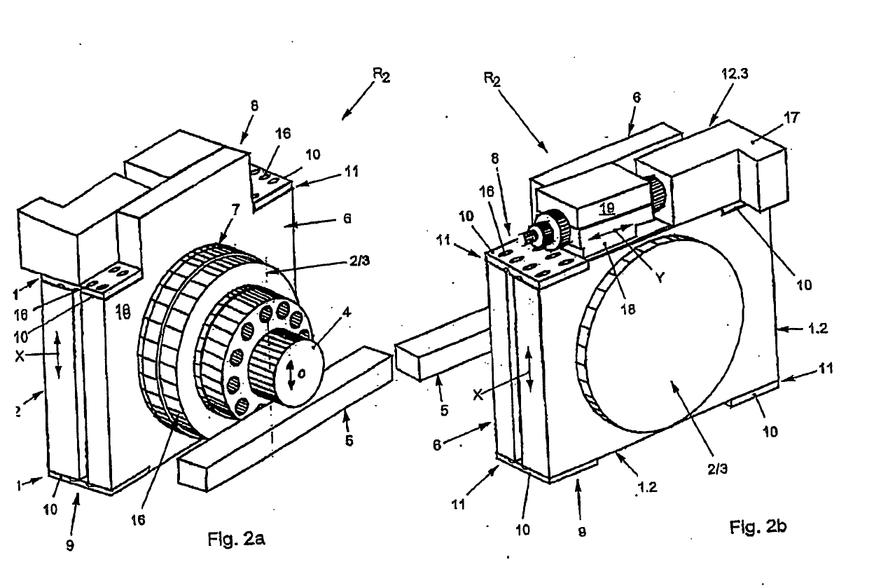

In the illustrative embodiment of the present invention according to FIGS. 2a and 2b, a further linear drive R₂ is shown that essentially exhibits the components described above.

Instead of the actuators 12.1, 12.2 installed on each side, an actuator 12.3 is designed as a spindle drive 17 that in the area of one upper side 8 is preferably firmly connected to the retaining element 1.2.

The retaining element 1.2 is slightly distant from the receiving element 6. Retaining element 1.2 and receiving element 6 are linked by corresponding guide elements 11 formed as leaf spring elements 10. The leaf spring elements 10 are preferably located in corresponding flanges, not referenced here, of retaining element 1.1, 1.2 or receiving element 6 and connect these to one another. The leaf spring elements 10 permit a linear guidance as indicated in the direction of the double arrow X, while in the preferred illustrative embodiment the receiving element 6 is fixed. Linear guides 5, swallow tail-shaped guides or similar guides can be employed instead of the leaf spring elements 10 as guide elements 11. The invention is not limited to these aspects.

The spindle drive 17 is connected to a spindle and a wedge 18 that can move back and forth in the direction Y shown. The wedge 18 is connected to a flange 19 that extends roughly perpendicularly from the receiving element 6 in the area of the upper side 8 and is permanently attached herewith.

By moving the wedge 18 in the direction of the double arrow Y shown, the retaining element 1.2 can be moved back and forth in the direction of the double arrow X shown in relation to the receiving element 6. In this way the retaining element 1.2, motor element 2 and/or integrated drive 3 with connected pinion 4 can be moved back and forth in relation to a linear guide 5 in the direction of the double arrow X shown, actively drivable and variable during operation, in order to guarantee freedom from backlash and an exact two-flank contact.

Here again, force and/or position sensors 16 are assigned to the motor element 2 and/or integrated drive 3 that determine a changing horizontal and vertical force during operation of the pinion 4 in relation to the linear guide 5. This measurement of the force allows the corresponding actuator 12.3 or spindle drive 17 to be actuated in order to move the pinion 4 or the retaining element 1.2 in relation to the receiving element 6 and hence to change a preload force in response to changing accelerations, loads or other such parameters.

The corresponding leaf spring elements 10 can here also be provided with force and/or position sensors 16 in order to measure the corresponding forces or preloads during operation and to control or vary the preload forces even during operation by actuating the actuator 12.3.

Instead of piezo actuators or spindle drives with wedge, eccentric, toggle lever or spindle drives with levers can be employed. The present invention is not restricted to these aspects.

### LIST OF REFERENCE NUMBERS

1 Retaining element
2 Motor element
3 Integrated drive
4 Pinion
5 Linear guide
6 Receiving element
7 Opening
8 Upper side
9 Lower side
10 Leaf spring element
11 Guide element
12 Actuator
13 Connecting piece
14 Flange
15 Recess
16 Force and/or position sensor
17 Spindle drive
18 Wedge
19 Flange
R1 Linear drive
R2 Linear drive
X Double arrow direction
Y Double arrow direction

1-18. (canceled)

19. A linear drive with at least one motor element mounted on or in a retaining element, the at least one motor element driving a pinion directly or indirectly, optionally via an integrated drive, said pinion interacting with a linear guide, and
the retaining element being movable in relation to a receiving element by at least one actuator.

20. A linear drive with at least one motor element mounted on or in a retaining element, the at least one motor element driving a pinion directly or indirectly, optionally via an integrated drive, said pinion interacting with a linear guide, wherein in order to guarantee permanent freedom from backlash and/or permanent two-flank contact between said pinion and said linear guide, the retaining element can be controlled, moved or preloaded under active control during operation in response to a measurement of force in horizontal and/or vertical direction of the pinion via at least one actuator in relation to a receiving element.

21. The linear drive as claimed in claim 19, wherein the retaining element is coupled to the receiving element by at least one guide element and can move back and forth in a linear direction in relation to the receiving element.

22. The linear drive as claimed in claim 21, wherein each said guide element is designed as one of a leaf spring element, a linear guide, and a needle roller bearing.

23. The linear guide as claimed in claim 19, wherein the retaining element is slightly distant from the receiving element and arranged parallel thereto.

24. The linear drive as claimed in claim 23, wherein in each side area in an area of one upper side and in an area of one lower side of said retaining element and said receiving element, said receiving element and said retaining element are each linked to one another in flange areas by leaf spring elements.

25. The linear drive as claimed in claim 19, wherein at least one side area of the receiving element, a connecting piece engages at least partly in a recess of the retaining element and said at least one actuator is employed between a flange of the retaining element and the connecting piece.

26. The linear drive as claimed in claim 19, wherein each said actuator comprises one of a piezo actuator, a shape memory actuator, an electrically operated actuator, a mechanically operated actuator, and a hydraulically operated actuator.

27. The linear drive as claimed in claim 22, wherein at least one force and/or position sensor is assigned to the at least one guide element.

28. The linear drive as claimed in claim 19, wherein at least one force and/or position sensor is assigned to the at least one actuator.

29. The linear drive as claimed in claim 25, wherein at least one force and/or position sensor is assigned to the connecting piece in an area of the mounting of the at least one actuator.

30. The linear drive as claimed in claim 19, wherein at least one force and/or position sensor is assigned to the at least one motor element and/or the integrated drive.

31. The linear drive as claimed in claim 19, wherein an actuator in the form of a spindle drive for linear movement of a wedge is mounted on the retaining element in an area of one upper side.

32. The linear drive as claimed in claim 31, wherein a flange is assigned to the receiving element that interacts with the wedge of the spindle drive of the retaining element.

33. A process for the operation of a linear drive with a motor element mounted on or in a retaining element, the motor element driving a pinion, optionally via an integrated drive, said pinion interacting with a linear guide,
said process comprising
measuring a force of the pinion in relation to the linear guide in a horizontal and/or a vertical direction, and determining and/or setting a preload force of the pinion in relation to the linear guide in order to guarantee a permanent freedom from backlash and/or a permanent two-flank contact between the pinion and the linear guide.

34. The process as claimed in claim 33, further comprising during operation with changing accelerations and/or speeds and/or loads and/or dead weights a preload force between said pinion and said linear guide can be determined and/or changed and/or controlled by permanent force measurement in horizontal and/or vertical direction for the control of a plurality of actuators.

35. The process as claimed in claim 33, further comprising controlling the preload force between the pinion and the linear guide depending on acceleration during operation in order to guarantee a permanent freedom from backlash and/or a permanent two-flank contact between the pinion and the linear guide.

36. The process as claimed in claim 33, further comprising via the guide elements, in particular the leaf spring elements, permanently setting a preload force via the at least one actuator and permanently changing the preload force and/or adapting the preload force during operation to change accelerations and/or loads and/or speeds.
